(19) United States
(12) Patent Application Publication
(10) Pub. No.: US 2007/0025344 A1
(43) Pub. Date: Feb. 1, 2007

(54) Connectivity enhancement

(75) Inventors: Michael A. Rothman, Puyallup, WA (US); Vincent J. Zimmer, Federal Way, WA (US)

Correspondence Address: VENABLE LLP, P.O. BOX 34385, WASHINGTON, DC, 20043-9998, US

(73) Assignee: Intel Corporation, Santa Clara, CA (US)

(21) Appl. No.: 11/178,414

(22) Filed: Jul. 12, 2005

(51) Int. Cl. H04L 12/66

(52) U.S. Cl. 370/356

(57) ABSTRACT

Digital data may be communicated by a central processing node to and from at least one digital telephone node of an internal network that includes the central processing node, and digital data may be communicated by the central processing node to and from at least one telephone node coupled to an external network to facilitate telephone communications between said digital telephone node of said internal network and said telephone node coupled to said external network.

### BACKGROUND OF THE INVENTION

In the past, homes and businesses have been wired for analog telephone service. This has required wiring to each physical area for each separate telephone line (i.e., different telephone number/extension) to be supported in that physical area.

More recently, digital telephony, for example, voice-over-Internet Protocol (VoIP), has come into existence (note that, for the purposes of this application, VoIP is intended to also include general voice-over-packet (VoP)). However, this has still required the use of separate wiring, and also separate interfacing equipment, for separate lines. Furthermore, neither digital nor analog telephony has accounted for a simple manner in which to enable/disable/control lines.

### BRIEF DESCRIPTION OF THE DRAWINGS

Various embodiments of the invention will now be described in connection with associated drawings, in which:

FIG. 1 depicts a schematic diagram of a system according to an embodiment of the present invention;

FIG. 2 depicts a further schematic diagram of a system according to an exemplary embodiment of the invention;

FIG. 3 depicts a further schematic diagram of a system according to an exemplary embodiment of the invention;

FIG. 4 shows a schematic illustration of different operations that may be carried out according to various exemplary embodiments of the invention;

FIG. 5 gives a flowchart of a method according to an exemplary embodiment of the invention;

FIG. 6 gives a flowchart of a method according to an exemplary embodiment of the invention;

FIG. 7 shows a schematic block diagram of an apparatus that may be used in implementing various exemplary embodiments of the invention.

### DETAILED DESCRIPTION OF EMBODIMENTS OF THE INVENTION

In the following description, numerous specific details are set forth. However, it is understood that embodiments of the invention may be practiced without these specific details. In other instances, well-known circuits, structures, and/or techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

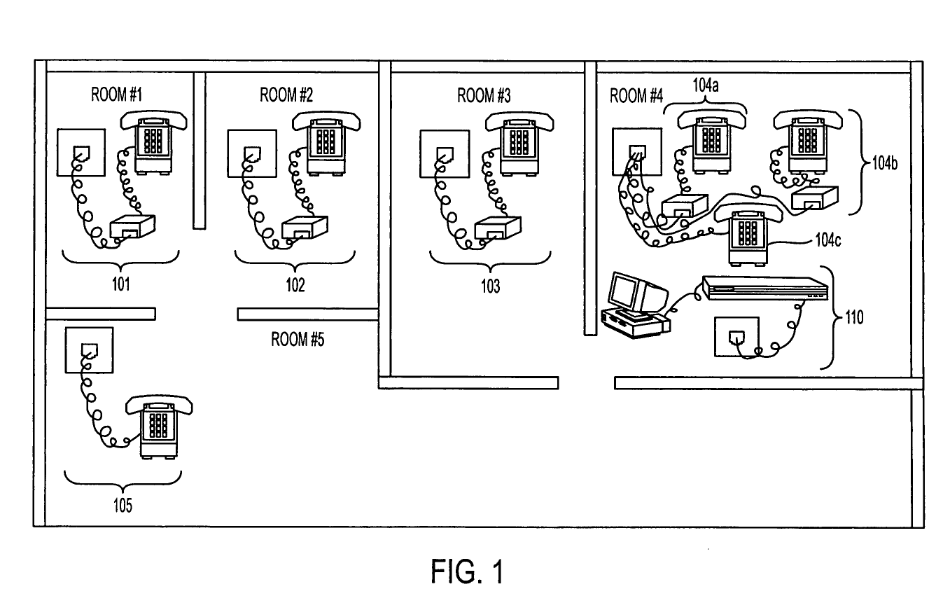

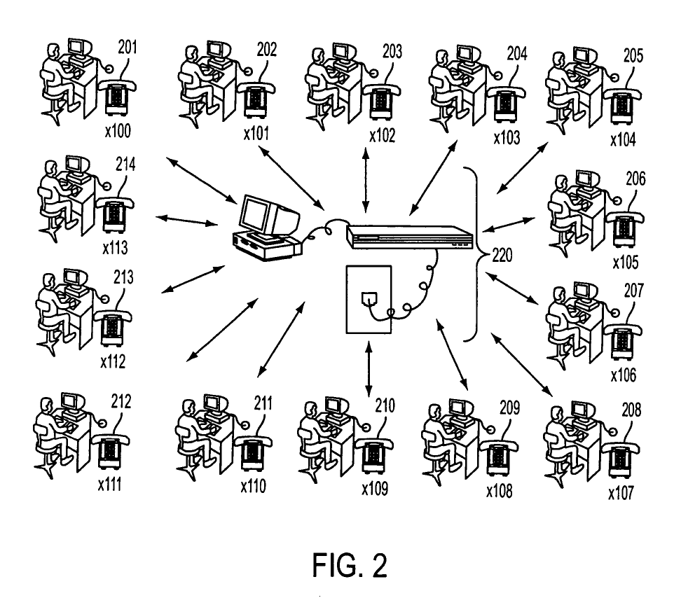

FIGS. 1 and 2 show exemplary implementations of systems according to embodiments of the invention. An exemplary system may correspond, for example, but is not limited to, a residential or business setting. As shown in FIG. 1, the system may span multiple rooms (e.g., Room #1-Room #5, as shown), or it may implemented in a single room (as might be illustrated by Room #4).

As shown in FIG. 2, rather than having separate lines, according to embodiments of the invention, each telephone in a system may be designated with a different extension (in FIG. 2, designated as “×100” through “×113,” although the invention is not limited to such designations).

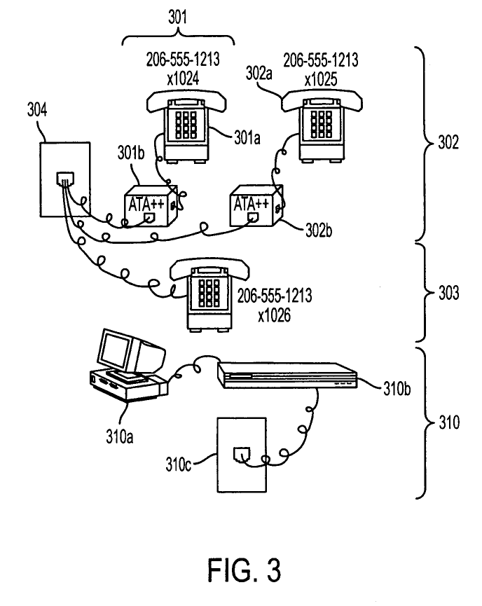

In particular, as reflected in FIGS. 1 and 2, remote telephone equipment, 101-105 or 201-214, respectively, is coupled by a digital communication medium to a central processing node, 110 or 220, respectively. Central processing mode 110 or 220 connects to a communication network, for example, the Internet, to act as an intelligent conduit telecommunications. The various components of the systems shown in FIGS. 1 and 2 may be as shown and discussed in connection with FIG. 3.

FIG. 3 shows a further system according to an embodiment of the invention. The system of FIG. 3 shows three telephone nodes, 301-303, although the invention is not limited to three, and may include an arbitrary number of such nodes. Nodes 301-303 may comprise a digital telephone (e.g., an Internet telephone), as in node 303. Alternatively, as shown for nodes 301 and 302, an analog telephone 301a, 302a may be coupled to an analog telephone adapter (ATA) 301b, 302b to adapt the analog telephone for digital communications. According to a further alternative implementation, a node 301-303 may comprise a computer system equipped to enable telephone communications. Each node 301-303 may have the same basic telephone number (shown as 206-555-1213 in FIG. 3), but may be assigned a different extension (e.g., ×1024, ×1025, and ×1026, respectively).

Each telephone node 301-303 may be coupled to a central processing node 310, which may provide an interface for communications with stations outside of the system. The coupling between the telephone nodes 301-303 and the central processing node 310 may be hard-wired, e.g., using wall jacks (e.g., 304), or wireless communication of any known or as yet to be discovered type may be used. Central processing node 310 may comprise a computer 310a, a router 310b, and at least one external connection, shown here as, but not limited to, a wall jack 310c (again, this may be a hard-wired or wireless connection). Computer 310a and router 310b may, alternatively, be implemented as a single unit.

The central processing node 310, and in particular, computer 310a and router 310b, may serve multiple roles. Central processing node 310 may serve as a proxy between telephone nodes 301-303 and one or more external communication networks (for example, the Internet; in this case, the technology may support Voice over Internet Protocol (VoIP)). Central processing node 310 may also serve to provide control over the network of telephone nodes. In this role, central processing node 310 may be used to activate and/or to deactivate extensions, to control access (e.g., permitting or preventing external calls to/from a given extension), and to provide other features (e.g., enabling multiple extensions to ring when a single call arrives, call forwarding among extensions, broadcast features, access to multiple extensions from a single telephone node, etc.).

In particular, for the purpose of providing various features, central processing node 310 may maintain a database of the extensions of the system. This database may include, for example, indications reflecting routing of calls, access permissions, etc. To establish a new extension, a new entry may be added to the database. Similarly, an extension may be removed by removing its entry from the database. This may be done by a user at computer 310a or there may be provisions for remote accessing of the database by a user at a telephone node 301-303 or through an external connection. For example, it may be possible for a user to enter an access code to allow him/her to modify the database remotely.

A further feature that may implemented is the establishment of a temporary extension for a predefined period of time. The database may permit a user to establish an extension and to enter start and end dates and/or times for its activation. Then, the system may automatically deactivate the extension when its time period expires.

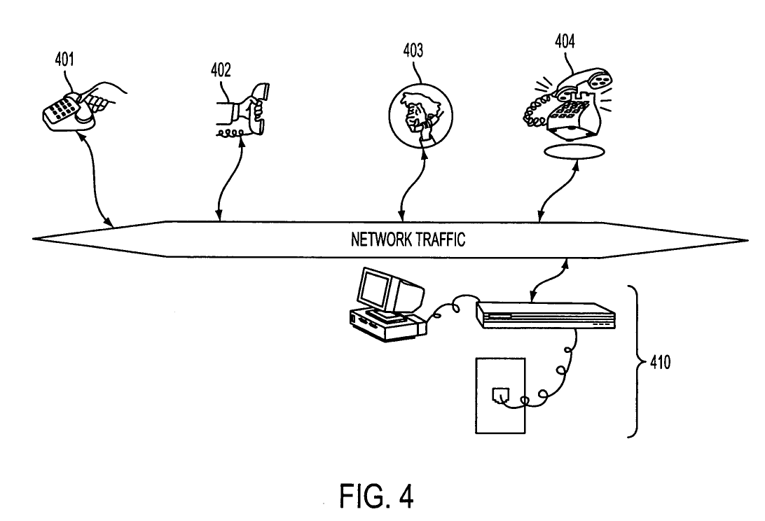

FIG. 4 shows an illustration indicating various operations that may be carried out in an implementation of a system according to embodiments of the invention. When a user initiates a call from within the system, for example, by picking up a handset, as indicated by reference numeral 401, this may result in the creation of a data packet that may contain identification data. This data packet may be pushed to central processing node 410 for processing to establish a call, either internal to the system or outside of the system. A user may, optionally, be able to dial an account code to designate an extension to be used; however, the default operation may be to associate a particular telephone node with a particular account/extension. At this point, a dial tone may be provided 402. In 403, a conversation may take place, during which packets may be constructed and transmitted and received and interpreted, for example, using a standard VoIP handshake procedure.

For an incoming call 404, a remote user (i.e., a user outside of the system) may dial the telephone number of the system (i.e., without an extension number). A verbal prompt may be provided to the remote user to enter an extension number. A connection may then be established to the appropriate telephone node, and a conversation may proceed, as in 403.

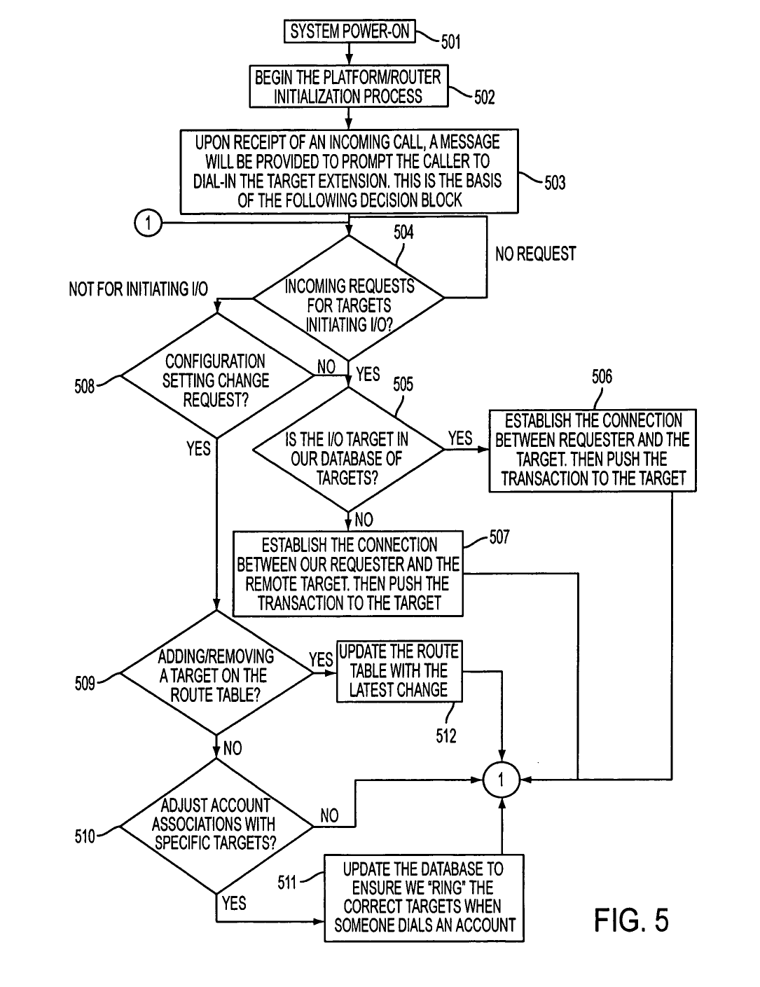

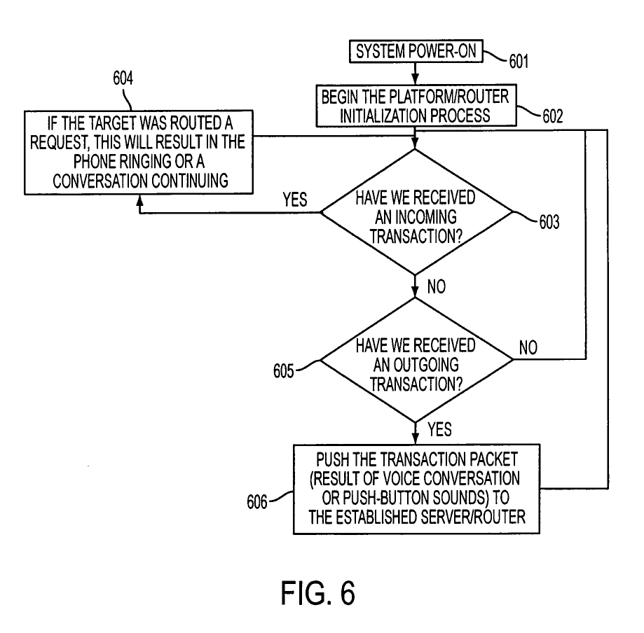

FIGS. 5 and 6 illustrate some of the more specific operations of the central processing node and the telephone nodes, respectively, in further detail, according to some embodiments of the invention. In particular, FIG. 5 shows an exemplary flowchart of a process that may be implemented by an exemplary central processing node. Upon power-on 501, the central processing node may initialize 502. An incoming call may be received 503, either from within the system or from outside the system, and in response, the caller may be prompted to dial a target extension. This may result in the entry by the caller of a target extension and/or, if the system permits it, a remote access code.

The process may next proceed with decision block 504. Block 504 may be used to determine if there are incoming requests for target nodes (e.g., VoIP targets) that initiate I/O. If there are no requests at all, the process may loop back to block 504 until at least one request is received. If a request is received, and it is for initiating I/O, the process may continue with block 505, which may determine if the I/O target is in the system database. If the target is in the system database, a connection may be established, and data may be pushed to the desired target 506. If the target is not in the system database, this may indicate the presence of an outgoing call to a remote target, and the process may proceed with block 507. From either block 506 or block 507, the process may loop back to block 504 to check for additional requests.

If block 504 determines that an incoming request is not for initiating I/O (that is, not for establishing a call), it may be a request to reconfigure the system, and the process may continue with block 508, which may determine if the request is a configuration setting change request. If it is not, the process may proceed with block 505, as discussed above. Otherwise, the process may proceed with block 509, which may determine if the request is a request to add or remove a node from the system routing table (i.e., the above-mentioned database). If yes, then the routing table may be updated 512, and the process may loop back to block 504. If no, then the process may proceed to block 510 and may determine if the request seeks to adjust account associations with specific nodes. If no, then the system loops back to block 504, as this may indicate an error in the request. If yes, then the database may be updated to ensure that a correct target is “rung” when someone dials a specific account/extension.

FIG. 6 shows a flowchart of a process that may be implemented in an ATA, digital telephone, computer, or any other platform used to implement a telephone node, according to some embodiments of the invention. Following power-on 601, the platform may be initialized 602. The process may then proceed to block 603 and may determine if an incoming transaction has been received. If yes, then this may indicate that a request has been sent to this node, and this may result, for example, in a “ringing” (or other indication of an incoming call) or in a conversation continuing 604. If no, then the process may proceed to block 605 and may determine if an outgoing transaction has been received (e.g., from a user of the node speaking or entering information on a telephone keypad). If yes, the process may continue with block 606 and may push a transaction packet to the central processing node, after which the process may loop back to block 603. If no, the process may just loop back to block 603.

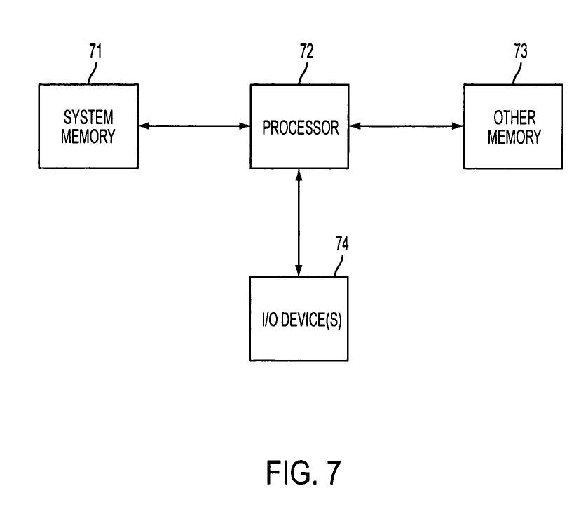

Some embodiments of the invention, as discussed above, may be embodied, at least in part, in the form of software instructions on a machine-accessible medium. Such an embodiment may be illustrated in FIG. 7. The computer system of FIG. 7 may include at least one processor 72, with associated system memory 71, which may store, for example, operating system software and the like. The system may further include other additional memory 73, which may, for example, include software instructions to perform various applications. System memory 71 and other memory 73 may comprise separate memory devices, a single shared memory device, or a combination of separate and shared memory devices. The system may also include one or more input/output (I/O) devices 74, for example (but not limited to), keyboard, mouse, trackball, printer, display, network connection, etc. The present invention, or parts thereof, may be embodied as software instructions that may be stored in system memory 71 or in other memory 73. Such software instructions may also be stored in removable or remote media (for example, but not limited to, compact disks, floppy disks, etc.), which may be read through an I/O device 74 (for example, but not limited to, a floppy disk drive). Furthermore, the software instructions may also be transmitted to the computer system via an I/O device 74, for example, a network connection; in such a case, a signal containing the software instructions may be considered to be a machine-accessible medium.

The invention has been described in detail with respect to various embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

What is claimed is:

1. A method comprising:
communicating digital data, by a central processing node, with at least one digital telephone node of an internal network that includes the central processing node; and
communicating digital data, by said central processing node, with at least one telephone node coupled to an external network to facilitate telephone communications between said digital telephone node of said internal network and said telephone node coupled to said external network.

2. The method according to claim 1, wherein said communicating digital data with at least one digital telephone node comprises:
receiving at least one data packet from said digital telephone node; and
identifying a target for a call from said digital telephone node if said at least one data packet includes a request for a call.

3. The method according to claim 2, further comprising:
communicating digital data with a second digital telephone node of said internal network if said target corresponds to a digital telephone node of said internal network.

4. The method according to claim 2, wherein said communicating digital data with at least one telephone node coupled to an external network comprises facilitating a call between said digital telephone node and said telephone node coupled to said external network if said target corresponds to a telephone node coupled to said external network.

5. The method according to claim 2, wherein said communicating digital data with at least one digital telephone node further comprises:
changing a configuration setting if said at least one data packet contains a request to change a configuration setting.

6. The method according to claim 5, wherein said communicating digital data with at least one digital telephone node further comprises:
accepting an access code to permit said changing a configuration setting.

7. The method according to claim 5, wherein said changing a configuration setting comprises:
altering at least one entry of a database corresponding to said internal network.

8. The method according to claim 5, wherein said changing a configuration setting comprises at least one of the group consisting of:
updating a routing table; and
adjusting an account associated with at least one digital telephone node.

9. The method according to claim 1, wherein said communicating digital data with at least one telephone node coupled to an external network comprises:
receiving at least one data packet containing information from said telephone node coupled to said external network; and
identifying a digital telephone node of said internal network as a target for a call from said telephone node if said at least one data packet includes a request for a call.

10. The method according to claim 9, said communicating digital data with at least one telephone node coupled to an external network further comprises:
prompting a user of said telephone node coupled to said external network to enter an extension corresponding to a digital telephone node of said internal network; and
wherein said identifying is performed based on said extension.

11. The method according to claim 9, wherein said communicating digital data with at least one telephone node coupled to an external network further comprises:
changing a configuration setting if said at least one data packet contains a request to change a configuration setting.

12. The method according to claim 11, wherein said communicating digital data with at least one telephone node coupled to an external network further comprises:
accepting an access code to permit said changing a configuration setting.

13. A method comprising:
communicating, by a digital telephone node of an internal network, digital data with a central processing node of said internal network, wherein said digital data corresponds to an incoming transaction or an outgoing transaction with respect to said digital telephone node; and
performing an operation selected from the group consisting of establishing a call and continuing a call, based on information received from one of the group consisting of said central processing node and a user of said digital telephone node.

14. The method according to claim 13, wherein, in the case of an incoming transaction, said continuing a call comprises forwarding information to said user.

15. The method according to claim 13, wherein, in the case of an incoming transaction, said establishing a call includes causing said digital telephone node to ring.

16. A machine-accessible medium containing instructions that, when executed by a processor, cause said processor to perform the method comprising:
communicating digital data, by said processor, with at least one digital telephone node of an internal network that includes said processor; and
communicating digital data, by said processor, with at least one telephone node coupled to an external network to facilitate telephone communications between said digital telephone node of said internal network and said telephone node coupled to said external network.

17. The machine-accessible medium according to claim 16, wherein said communicating digital data with at least one digital telephone node comprises:
receiving at least one data packet from said digital telephone node; and
identifying a target for a call from said digital telephone node if said at least one data packet includes a request for a call.

18. The method according to claim 16, wherein said communicating digital data with at least one telephone node coupled to an external network comprises:
receiving at least one data packet containing information from said telephone node coupled to said external network; and
identifying a digital telephone node of said internal network as a target for a call from said telephone node if said at least one data packet includes a request for a call.

19. A machine-accessible medium containing instructions that, when executed by a processor, cause said processor to perform the method comprising:
communicating, by a digital telephone node of an internal network, digital data with a central processing node of said internal network, wherein said digital data corresponds to an incoming transaction or an outgoing transaction with respect to said digital telephone node; and
performing an operation selected from the group consisting of establishing a call and continuing a call, based on information received from one of the group consisting of said central processing node and a user of said digital telephone node.

20. The method according to claim 19, wherein, in the case of an incoming transaction, said continuing a call comprises forwarding information to said user.

21. The method according to claim 19, wherein, in the case of an incoming transaction, said establishing a call includes causing said digital telephone node to ring.

22. A system comprising:
at least one digital telephone node to send and receive digital data; and
a central processing node coupled to said at least one digital telephone node to communicate digital data with said at least one digital telephone node, said central processing node and said at least one digital telephone node forming an internal network, said central processing node to further provide an interface to facilitate communications between said at least one digital telephone node and at least one telephone unit coupled to a network external to said internal network.

23. The system according to claim 22, wherein said network external to said internal network comprises the Internet.

24. The system according to claim 22, wherein said at least one digital telephone node comprises at least one unit selected from the group consisting of: a digital telephone; a computer equipped for telephony; and an analog telephone adapter coupled to an analog telephone.

25. The system according to claim 22, wherein said central processing node comprises:
a computer; and
a router coupled to said computer.
